(19) United States
(12) Patent Application Publication
(10) Pub. No.: US 2005/0069301 A1
(43) Pub. Date: Mar. 31, 2005

(54) Reduction of interference caused by PWM motors

(75) Inventors: Thomas James Gallagher, Lake Orion, MI (US); Hong Jiang, Rochester Hills, MI (US); Sergei Kolomeitsev, Rochester, MI (US); Benjamin L. Miciano, Auburn Hills, MI (US); Pirakalathan Pathmanathan, Lake Orion, MI (US); John R. Suriano, Auburn Hills, MI (US)

Correspondence Address: MATTHEW R. JENKINS, ESQ., 2310 FAR HILLS BUILDING, DAYTON, OH, 45419, US

(73) Assignee: VALEO ELECTRICAL SYSTEMS, INC., AUBURN HILLS, MI (US)

(21) Appl. No.: 10/675,372

(22) Filed: Sep. 30, 2003

(51) Int. Cl. H02P 7/29

(52) U.S. Cl. 388/829

(57) ABSTRACT

System for reducing electronic noise in a radio in a vehicle. Pulse Width Modulated, PWM, motors used in a vehicle receive pulses of electric current. These pulses have a Fourier spectrum of harmonics which can be picked up by a radio in the vehicle, causing the radio to produce unwanted noise. The invention reduces the noise by continually varying the base frequency of the PWM pulses, to thereby vary the spectrum of the noise. This varying spectrum is more difficult for humans to detect.

The invention reduces electronic interference caused by Pulse Width Modulated (PWM) motors, and particularly reduces noise which is traceable to such motors and heard in speakers in motor vehicles.

### BACKGROUND OF THE INVENTION

Pulse Width Modulation, PWM, is used to control the speed of many DC motors. In PWM, a sequence of pulses is applied to the motor. FIG. 1 illustrates one type of timing for pulses 3 applied to a motor 6. Each pulse is of a duration or “width” d, and the period is T. FIG. 2 illustrates another type of timing: the pulses are of longer duration d1, but the period T is the same.

Increasing the duration d, or width, of the pulses increases the energy delivered to the motor 6 during the period T, thereby increasing speed of the motor 6. Conversely, decreasing the duration d decreases the energy delivered to the motor 6 during the period T, thereby decreasing the speed of the motor 6.

The pulses are generated by rapidly opening and closing the switch 12 in FIG. 3. Switch 12 generally takes the form of a transistor.

The Inventor has observed a problem which PWM motors can cause in motor vehicles, and has developed a solution.

### OBJECTS OF THE INVENTION

An object of the invention is to provide an improved system for controlling PWM in electric motors in order to reduce electronic interference.

### SUMMARY OF THE INVENTION

In one form of the invention, the base frequency of a PWM pulse train is continually varied, in order to continually shift the frequency of the harmonics produced by the PWM pulse train. The continually shifting harmonics are not so easily detectable by the human ear as harmonics which remain at constant frequencies.

In one aspect this invention comprises a method of operating an electric motor, comprising applying a train of pulses to the motor, and while keeping motor speed substantially constant, modulating frequency of the pulses.

In another aspect this invention comprises the method of operating an electric motor, comprising applying PWM power of substantially constant duty cycle to the motor; and while applying said PWM power, varying harmonic content of said power.

In still another aspect this invention comprises an apparatus, comprising a motor vehicle, an electric motor within the vehicle, a PWM controller which applies pulses to the electric motor and shifts base frequency of the pulses while keeping motor speed substantially constant.

In yet aspect this invention comprises a method, comprising maintaining an electric motor within a motor vehicle, applying power pulses to the electric motor, and shifting base frequency of the power pulses while motor speed is substantially constant.

These and other objects and advantages of the invention will be apparent from the following description, the accompanying drawings and the appended claims.

### BRIEF DESCRIPTION OF THE DRAWINGS

FIGS. 1 and 2 illustrate pulse trains of similar frequency, but with pulses of different durations d;

FIG. 3 illustrates a switch used to generate the pulse train of FIGS. 1 and 2;

FIGS. 4 and 5 illustrate how a square wave can be constructed by adding sine waves of different frequencies, and illustrates a partial trigonometric Fourier Series;

FIG. 6 illustrates a group of equations used to compute an exponential Fourier Series;

FIGS. 7, 9, and 10 illustrate spectra of three different PWM pulse trains;

FIG. 8 illustrates amplitudes of the last summation in FIG. 5;

FIG. 11 is a flow chart illustrating processes undertaken by one form of the invention;

FIG. 12 is a timing diagram of a pulse, and defines terms used in FIG. 11; and

FIG. 13 illustrates one form of the invention.

### DETAILED DESCRIPTION OF THE INVENTION

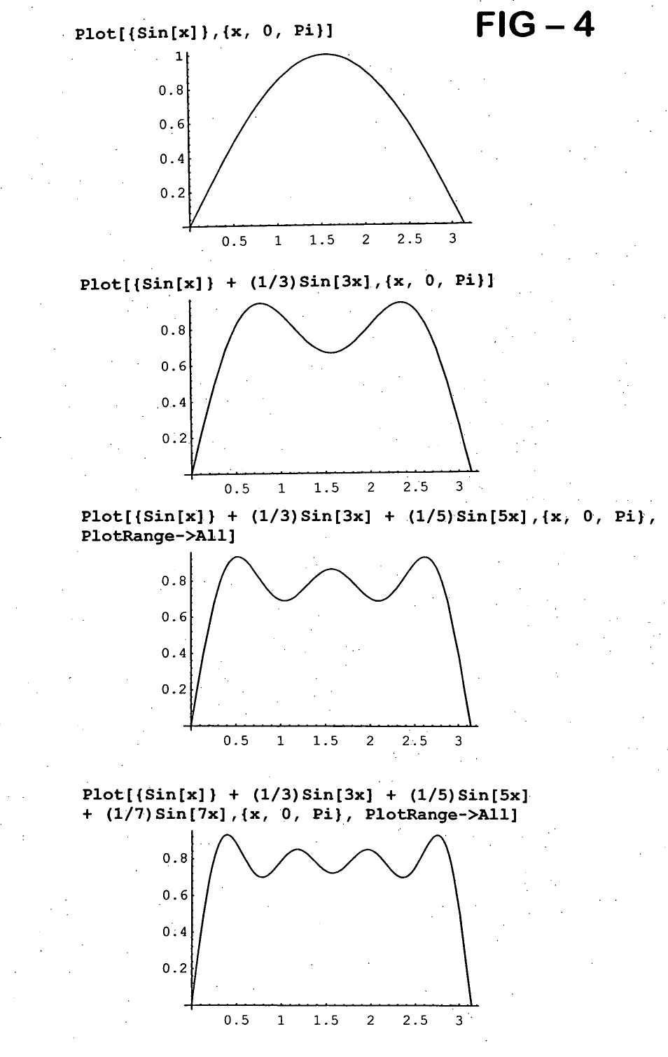

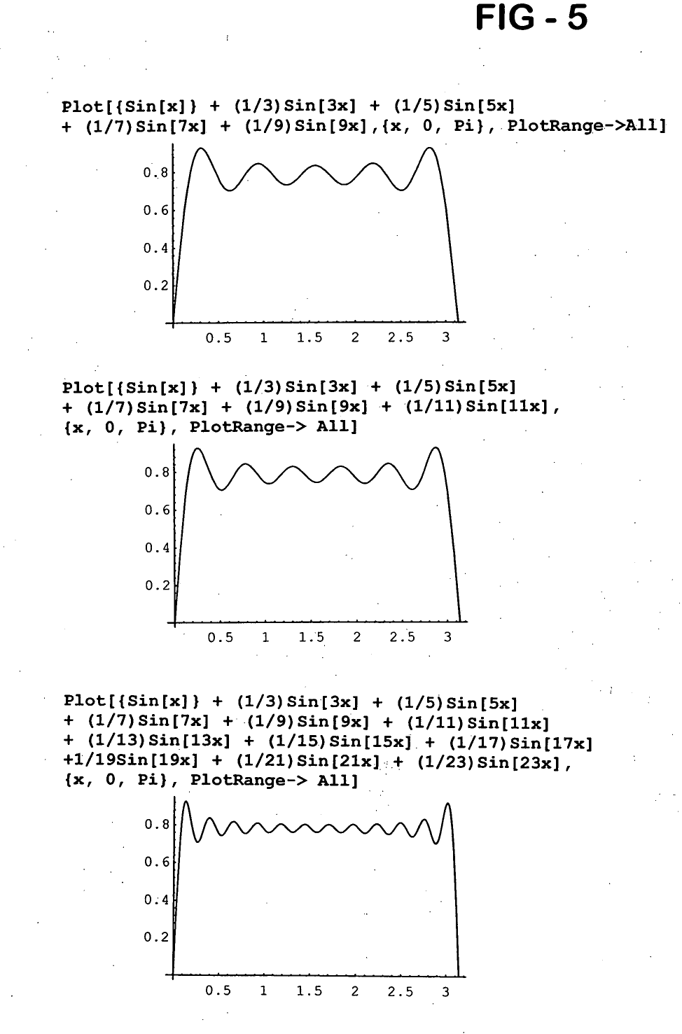

FIGS. 4 and 5 illustrate how addition of sine waves, as in a Fourier Series, can generate a square wave, and are considered self-explanatory. It is clear that as the number of sine waves of appropriate frequency and amplitude increases, their sum approaches a square wave.

In point of fact, in communications systems and in many branches of engineering, square-wave disturbances (whether electrical, acoustical, optical, mechanical, or of other forms) actually behave as a collection of the individual sine waves indicated in FIGS. 4 and 5.

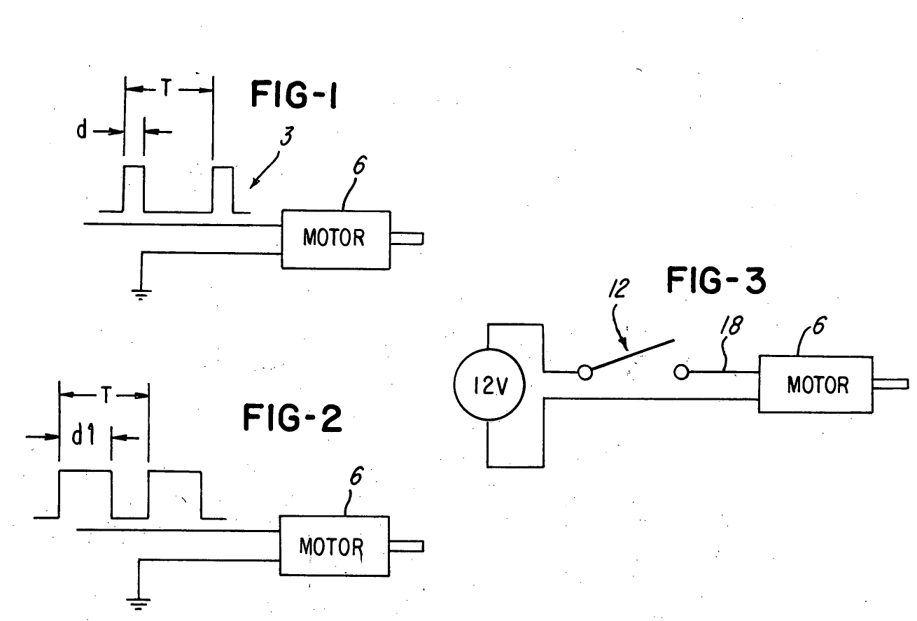

Consistent with that fact, the Inventor has observed that the use of PWM to control speed of motors in vehicles tends to introduce noise into devices such as radios, tape players, CD players, and possibly cellular telephones. These devices will be generically referred to as communication devices herein. The PWM pulses, such as those in FIGS. 1 and 2, produce noise which behaves as the sinusoids indicated in FIGS. 4 and 5.

One reason that the noise appears in the communication devices is that the electrical wires leading to the motor, such as wires 18 in FIG. 3, carry the sinusoidal electric currents represented by the sine waves indicated in FIGS. 4 and 5. Those currents create magnetic fields which couple directly with conductors in the communication devices. Another reason is that those currents migrate into the power supply of the communication devices.

A third reason is that for the sinusoids at higher frequencies, the wires 18 in FIG. 3 act as antennas, and radiate electromagnetic energy through the air, and into the communication devices, again introducing unwanted noise.

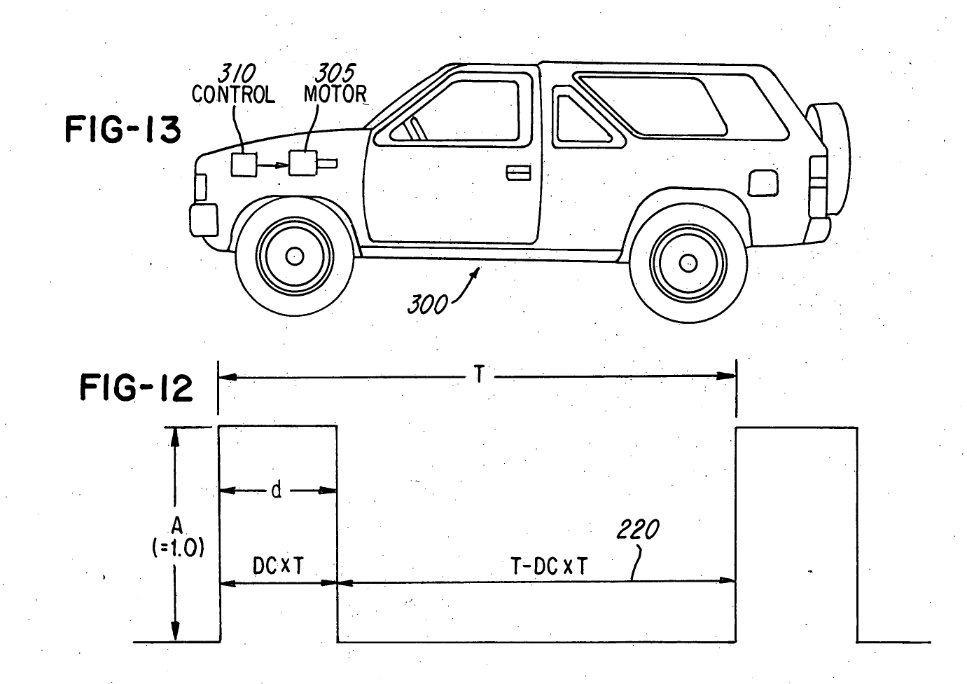

The Inventor has devised a stratagem for reducing this noise. In one form of the invention, the base frequency of the PWM power applied to the motor is continuously varied. That is, time T in FIG. 12 is continuously varied. However, the relative length of d, compared to T, is kept constant, in order to keep duty cycle constant, and thus motor speed constant.

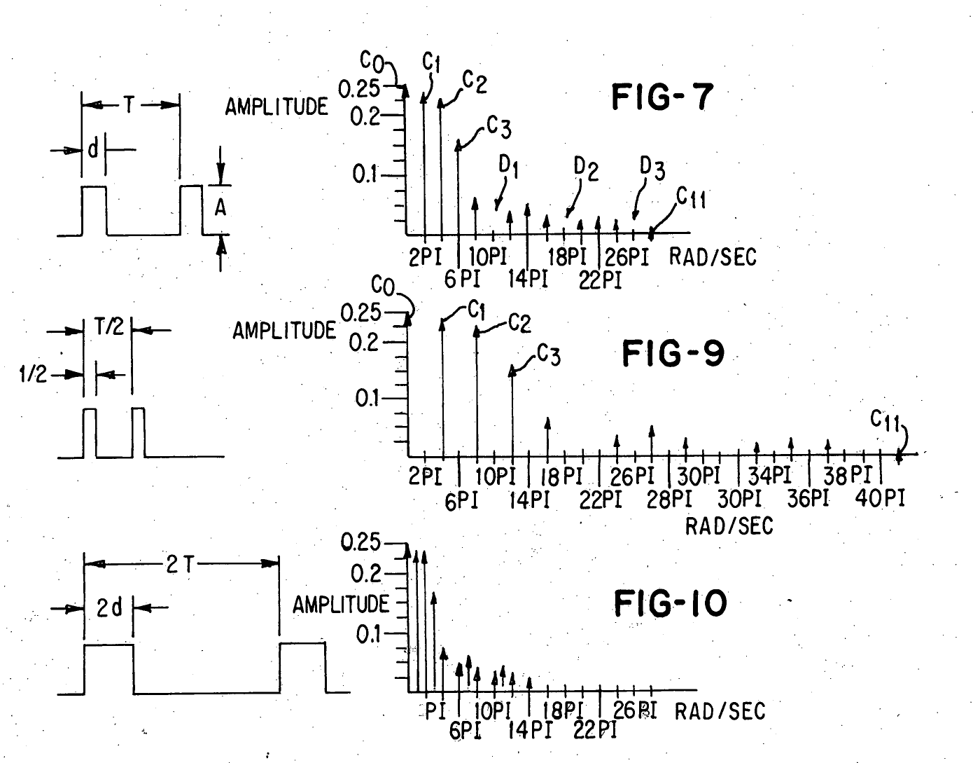

These variations are illustrated in FIGS. 7, 9, and 10, left sides. The variation causes the frequency spectrum of the pulse train to shift, as indicated on the right sides of the FIGS. The shifting spectra are more difficult for the human ear to detect, compared with a stationary spectrum.

To provide one explanation of why this continual variation reduces noise, this discussion will first compute the spectral distribution of a PWM pulse train. This discussion will then show how changing the frequency of the PWM pulse train will change that spectral distribution.

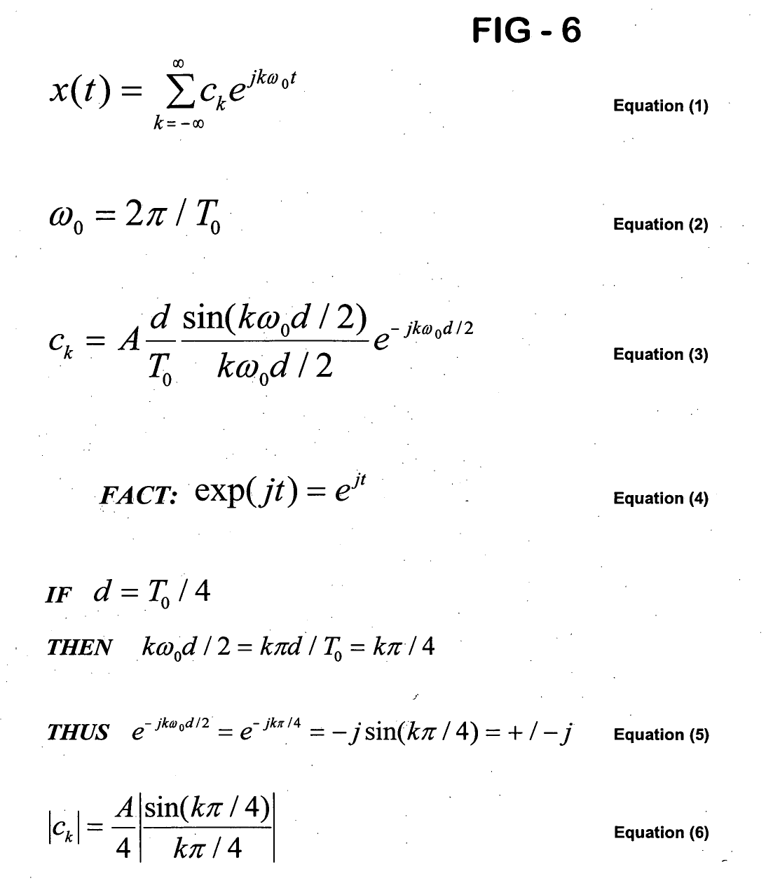

FIGS. 4 and 5 illustrated a trigonometric Fourier Series, which is so-called because the basic unit is a trigonometric function, namely, a sine wave in this example. It is perhaps mathematically simpler to now focus on the so-called exponential Fourier Series, which is defined in Equation 1 of FIG. 6.

Equation 1 is applicable when the signal x(t) is a pulse train, of the type shown in FIG. 12. Equation 1 indicates that the pulse train is equivalent to a sum of an infinite number of terms, each of the form ckexp(jw0t). Equation 3 indicates how each ck is computed in Equation 1.

The fourth row of FIG. 6 indicates a fact of mathematical notation: the exponential expression ejt can also be written as exp(jt). The latter will be used in this discussion, for convenience of printing.

Each ck represents the amplitude of a respective frequency component in the Fourier spectrum. The term A in Equation 3 is the amplitude of the PWM pulses in question, and will be assumed to be unity, for simplicity, as indicated in FIG. 12.

FIG. 4 can explain the concept of amplitudes of the harmonics. At the bottom of FIG. 4 is the plot of the sum of
sin [t]+(⅓) sin [3t]+(⅕) sin [5t]+(1/7) sin [7t].

The amplitudes of these terms are 1, ⅓, ⅕, and 1/7, respectively.

Similarly, each cₖ in FIG. 6 also represents an amplitude. This is illustrated by the fact that, by Euler's Identity, the expression exp(−jw₀d/2) in Equation 3 is equivalent to
−[cos (w₀d/2)+j sin (w₀d/2)].
Thus, each cₖ is multiplied by the two sinusoidal terms just stated. Each cₖ is thus an amplitude of a corresponding sinusoidal wave. Computation of these amplitudes will allow a study of their behavior, as the base frequency of the PWM pulse train is altered.

A simplifying assumption can be invoked, to reduce the complexity of the Fourier Series represented by Equation 1 in FIG. 6. Assume that the duty cycle of the pulses is 25 percent. That is, d in FIG. 12 is 25 percent of T. Under this assumption, the simplification of Equations 5 in FIG. 6 becomes available.

The simplification, in effect, eliminates the exponential term at the right side of Equation 3 in FIG. 6. The reason is that this exponential term becomes reduced to +/−j, as indicated in Equations 5. Since +/−j is only a phase factor, it does not change the amplitude of cₖ in Equation 3. Since this discussion is focusing on the amplitudes of the cₖ's, the expression for computing cₖ reduces to that of Equation 6 in FIG. 6.

If should be observed that this simplification does not alter the general behavior of spectrum-shifting illustrated in FIGS. 7, 9, and 10. This general behavior is still found for other duty cycles. This general behavior is easier to illustrate mathematically for a duty cycle of ¼, because such a duty cycle allows the simplification just described.

TABLE 1, below, computes the cₖ's for the first 15 values of k.

TABLE 1

| k | ABS sin[(k × PI/4)/(k × PI/4)] | cₖ |
|---|---|---|
| 0 | 1.0 | 1.0/4 |
| 1 | 0.92 | 0.92/4 |
| 2 | 0.63 | 0.63/4 |
| 3 | 0.30 | 0.30/4 |
| 4 | 0.0 | 0.0 |
| 5 | 0.18 | 0.18/4 |
| 6 | 0.21 | 0.21/4 |
| 7 | 0.13 | 0.13/4 |
| 8 | 0.0 | 0.0 |
| 9 | 0.10 | 0.10/4 |
| 10 | 0.13 | 0.13/4 |
| 11 | 0.08 | 0.08/4 |
| 12 | 0.0 | 0.0 |
| 13 | 0.07 | 0.07/4 |
| 14 | 0.09 | 0.09/4 |

In applying Equation 6 in FIG. 6, this Table first computed the term within the absolute-value-brackets in Equation 6, to produce the central column of the Table. Then, it was assumed that A equals unity, as stated above. Each value of the central column is then divided by 4, producing the right-hand column. The right-hand column of the Table indicates the ck for each value of k, from zero to 14.

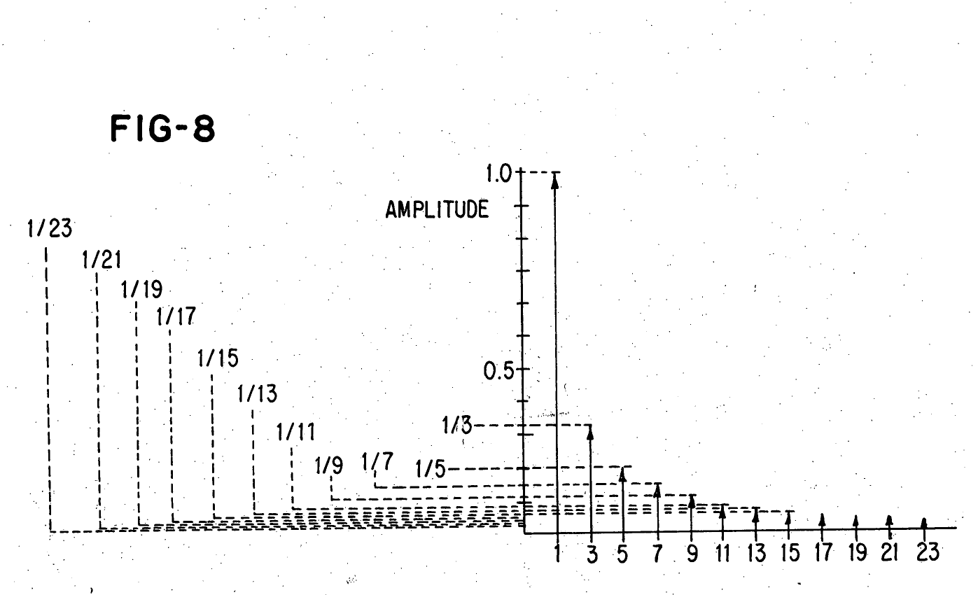

The amplitudes of the cₖ's are plotted in FIG. 7. To provide a frame of reference, the corresponding amplitudes from FIG. 5, last summation, are plotted in FIG. 8. It should be observed that plotting k on the horizontal axis in FIG. 8 is essentially the same as plotting frequency on the horizontal axis, because, to plot frequency, each k would be multiplied by a constant, or base frequency. Using frequency on the horizontal axis, as opposed to k-values, merely changes the units of the axis, but not the shape of the plot.

FIGS. 7 and 8 both indicate the relative amplitudes of the frequency components of their respective Fourier Series.

In FIG. 7, points D1, D2, and D3 indicate frequencies where the values of ck are zero. These correspond to k-values of 4, 8, and 12 in Table 1.

FIG. 7 indicates the spectrum of the first twelve harmonics for the pulse train at the left side of FIG. 7, given the assumptions that (1) the duty cycle is 25 percent, (2) amplitude A is one unit, and (3) time T0 is one second.

Assume that the period T0 is cut in half, as indicated in FIG. 9, left side, while the duty cycle remains constant. Base frequency of the pulse train, w0, of the spectrum doubles, as indicated by Equation 2 in FIG. 6. Thus, the spectrum becomes expanded as shown in FIG. 9.

In FIG. 9, the bandwidth occupied by the first fourteen harmonics has doubled, compared with FIG. 7.

Assume now that the period T0 doubles, as in FIG. 10, left side. Duty cycle remains at 25 percent. By virtue of equation 2 in FIG. 6, the base frequency w₀ of the spectral components is cut in half. Thus, the harmonics become compressed as shown in FIG. 10.

FIGS. 7, 9, and 10 can be summarized as follows. FIG. 7 shows a base frequency. The first twelve harmonics occupy a given bandwidth.

When the base frequency is doubled, as in FIG. 9, the bandwidth occupied by the first twelve harmonics also doubles. Stated another way, the frequency of each harmonic component doubles.

When the base frequency is cut in half, as in FIG. 10, the bandwidth occupied by the first twelve harmonics also is cut in half. The frequency of each component is cut in half.

Therefore, by continually varying the base frequency of the pulse trains shown on the left sides of FIGS. 7, 9, and 10, one continually shifts the harmonics produced. The harmonic content is continually altered. Yet, if the duty cycle of the pulses remains the same, motor speed remains constant.

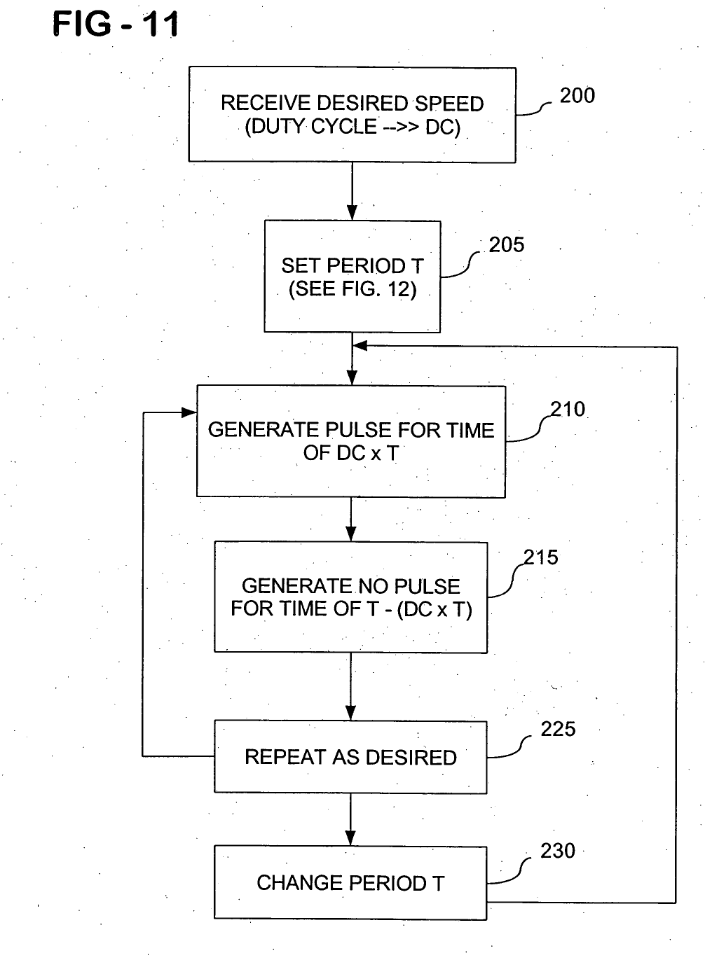

FIG. 11 is a flow chart illustrating processes undertaken by one form of the invention, and FIG. 12 is a timing diagram illustrating variables used in the flow chart.

Block 200 in FIG. 11 indicates that a variable called DUTY CYCLE is received from a user. DUTY CYCLE, abbreviated DC, controls the speed of the motor.

DUTY CYCLE, DC, can be generated by a shaft encoder (not shown), wherein the user manually rotates the shaft to a position, and the encoder produces a binary number corresponding to the position. For example, assume that the shaft encoder selectively produces a number from zero to 31, or from 00000 to 11111 in binary. An implied denominator of 31 is used. If the shaft encoder outputs 1 (decimal), then the fraction, or duty cycle, indicated is 1/31. If the shaft encoder outputs 13 (decimal), then the fraction, or duty cycle, indicated is 13/31, and so on.

Block 205 indicates that a period T in FIG. 12 is set, such as at 100 milliseconds. Block 210 indicates that a pulse is generated for a time duration of DC×T. That duration is indicated in FIG. 12. If DC is ½, then the pulse will be generated for 500 milliseconds in this example. The pulse can be generated by allowing the microprocessor (not shown) running the logic of FIG. 11 to control the gate of a Field Effect Transistor, FET, which delivers current to the motor. FIG. 3 illustrates a switch which can represent the FET.

Block 215 in FIG. 11 indicates that the pulse is turned off for a duration of T−(DC×T), namely, period 220 in FIG. 12. Block 225 in FIG. 11 indicates that the ON-OFF sequence is repeated a selected number of times.

Then, after that repetition, block 230 indicates that the duration of T is changed. This changes the base frequency of the pulses, yet does not change motor speed significantly, if at all, because duty cycle remains the same (assuming that the output of the shaft encoder under consideration is not altered). The logic returns to block 210, pulsing is applied to the motor with the new frequency, and then the duration of T is again changed, and so on.

The range over which the frequency is changed can be any practical value, such as, for example, from a frequency of 1,000 Hz to 10 million Hz. As a specific example, the base frequency can be increased by 100 Hz every ½ second from 1,000 Hz to 10 million Hz.

FIG. 13 illustrates one form of the invention. A motor vehicle 300 contains a motor 305. A control 310 which implements the processes described herein, some of which are outlined in FIG. 11, controls frequency of pulses in a pulse width modulation system. The pulses are applied to the motor 305. It is not necessary that the speed of the motor be determined by a human, as by setting a shaft encoder as described above. Instead, a computer, such as the on-board master computer of the vehicle, can select the speed of the motor 305.

In one form of the invention, duty cycle of the pulses (i.e., DC/T in FIG. 12) is varied while the base frequency (1/T) is varied.

While the system and method described, constitute preferred embodiments of this invention, it is to be understood that the invention is not limited to this precise system and method, and that changes may be made in either without departing from the scope of the inventions, which is defined in the appended claims.

1. A method of operating an electric motor, comprising:
a) applying a train of pulses to the motor; and
b) while keeping motor speed substantially constant, modulating frequency of the pulses.

2. The method according to claim 1, wherein duty cycle of the pulses is kept substantially constant while frequency is modulated.

3. The method according to claim 1, wherein frequency of the pulses is varied from a first frequency f1 to a second frequency f2 which is 3 to 7 times larger than f1.

4. The method according to claim 2, wherein frequency of the pulses is varied from a first frequency f1 to a second frequency f2 which is 3 to 7 times larger than f1.

5. The method according to claim 4, wherein frequency f1 is about 1,000 Hz.

6. The method according to claim 1, and further comprising:
c) using said motor to power a component in a vehicle.

7. The method of operating an electric motor, comprising:
a) applying PWM power of substantially constant duty cycle to the motor; and
b) while applying said PWM power, varying harmonic content of said power.

8. The method according to claim 5, and further comprising:
using said motor to power a component in a vehicle.

9. The method according to claim 3, and further comprising:
using said motor to power a component in a vehicle.

10. The method according to claim 2, and further comprising:
using said motor to power a component in a vehicle.

11. The method according to claim 4, and further comprising:
using said motor to power a component in a vehicle.

12. The method according to claim 7, wherein a selected group of harmonics of said power occupies a first bandwidth at one time and said group of harmonics occupies a second bandwidth, double the first bandwidth, at another time.

13. The method according to claim 7, wherein varying the harmonic content causes at least one harmonic frequency to change from a first frequency f1 to a second frequency f2, this is 30-100 percent greater than f1.

14. The method according to claim 7, wherein said motor is contained in a motor vehicle, and the harmonic content produces noise in a speaker of a communication device in the vehicle.

15. The method according to claim 7 wherein varying the harmonic content causes at least one harmonic to vary from a first frequency f1 randomly to a second frequency f2.

16. The method as recited in claim 7 wherein a switching between a first frequency f1 and a second frequency f2 is performed randomly.

17. The method according to claim 7 wherein varying the harmonic content causes a switch from a frequency f1 to a frequency f2 that is a random frequency.

18. An apparatus, comprising:
a) a motor vehicle;
b) an electric motor within the vehicle;
c) a PWM controller which
i) applies pulses to the electric motor and
ii) shifts base frequency of the pulses while keeping motor speed substantially constant.

19. The apparatus according to claim 18, wherein the PWM controller alters frequency spectrum of the pulses through the shifts.

20. A method, comprising:
a) maintaining an electric motor within a motor vehicle;
b) applying power pulses to the electric motor; and
c) shifting base frequency of the power pulses while motor speed is substantially constant.

21. The method according to claim 20, wherein shifting of the base frequency alters spectral content of the pulses.

22. The method according to claim 6, wherein the vehicle includes a communication device and said modulating shifts frequency of noise in said communication device.

23. The method according to claim 18, wherein the vehicle includes a communication device and shifting said base frequency shifts frequency of noise in said communication device.
